(19) United States
(12) Patent Application Publication
(10) Pub. No.: US 2025/0284675 A1
(43) Pub. Date: Sep. 11, 2025

(54) QUANTUM SERVICE VERSION REQUEST ROUTING

(71) Applicant: Red Hat, Inc., Raleigh, NC (US)

(72) Inventors: Leigh Griffin, Waterford (IE); Stephen Coady, Dublin (IE)

(21) Appl. No.: 18/597,262

(22) Filed: Mar. 6, 2024

(51) Int. Cl. G06F 16/21; G06N 10/80

(52) U.S. Cl. CPC G06F 16/219; G06N 10/80

(57) ABSTRACT

A computing device receives, from a client computing device, a request to access a quantum service, the request comprising a plurality of parameters associated with the quantum service, wherein a plurality of versions of the quantum service execute on a plurality of quantum computing devices. The quantum computing device identify characteristics of the plurality of versions of the quantum service. The quantum computing device identify characteristics of the plurality of quantum computing devices. The quantum computing device determine a version from among the plurality of versions of the quantum service to route the request to based on the request, the characteristics of the plurality of versions of the quantum service, and the characteristics of the plurality of quantum computing devices. The quantum computing device route the request from the client computing device to the version from among the plurality of versions of the quantum service.

### BACKGROUND

Quantum computing involves the use of quantum bits, referred to herein as “qubits,” which have characteristics that differ from those of classical (i.e., non-quantum) bits used in classical computing. Qubits may be employed by quantum services that are executed by quantum computing devices.

### SUMMARY

The examples disclosed herein implement a quantum strangler service that performs quantum service version request routing. In particular, the quantum strangler service can route a request for a quantum service to the best version of the quantum service based on several factors. The quantum strangler service can decompose the request and examine the capabilities and current state of the various versions of the quantum service and of the quantum computing devices in the quantum computing system. The capabilities and current state of the various versions of the quantum service and of the quantum computing devices can be weighed to determine the best version of the quantum service to receive the request.

In one example, a method for quantum service version request routing is disclosed. The method includes receiving, by a computing device from a client computing device, a request to access a quantum service, the request comprising a plurality of parameters associated with the quantum service, wherein a plurality of versions of the quantum service execute on a plurality of quantum computing devices. The method further includes identifying, by the computing device, characteristics of the plurality of versions of the quantum service. The method further includes identifying, by the computing device, characteristics of the plurality of quantum computing devices. The method further includes determining, by the computing device, a version from among the plurality of versions of the quantum service to route the request to based on the request, the characteristics of the plurality of versions of the quantum service, and the characteristics of the plurality of quantum computing devices. The method further includes routing, by the quantum computing device, the request from the client computing device to the version from among the plurality of versions of the quantum service.

In another example, a computing device for quantum service version request routing is disclosed. The computing device comprises a system memory, and a processor device communicatively coupled to the system memory. The processor device is to receive, from a client computing device, a request to access a quantum service, the request comprising a plurality of parameters associated with the quantum service, wherein a plurality of versions of the quantum service execute on a plurality of quantum computing devices. The processor device is further to identify characteristics of the plurality of versions of the quantum service. The processor device is further to identify characteristics of the plurality of quantum computing devices. The processor device is further to determine a version from among the plurality of versions of the quantum service to route the request to based on the request, the characteristics of the plurality of versions of the quantum service, and the characteristics of the plurality of quantum computing devices. The processor device is further to route the request from the client computing device to the version from among the plurality of versions of the quantum service.

In another example, a non-transitory computer-readable storage medium is disclosed. The non-transitory computer-readable storage medium stores thereon computer-executable instructions that, when executed, cause one or more processor devices to receive, from a client computing device, a request to access a quantum service, the request comprising a plurality of parameters associated with the quantum service, wherein a plurality of versions of the quantum service execute on a plurality of quantum computing devices. The instructions further cause the processor device to identify characteristics of the plurality of versions of the quantum service. The instructions further cause the processor device to identify characteristics of the plurality of quantum computing devices. The instructions further cause the processor device to determine a version from among the plurality of versions of the quantum service to route the request to based on the request, the characteristics of the plurality of versions of the quantum service, and the characteristics of the plurality of quantum computing devices. The instructions further cause the processor device to route the request from the client computing device to the version from among the plurality of versions of the quantum service.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of a quantum computing system in which examples of quantum service version request routing may be practiced;

FIG. 2 is a flowchart illustrating operations performed by the quantum computing system of FIG. 1 for quantum service version request routing, according to one example;

FIG. 3 is a block diagram of the quantum computing system of FIG. 1 for quantum service version request routing, according to one example;

FIG. 4 is a block diagram of the quantum computing system of FIG. 1 for quantum service version request routing, according to one example;

FIG. 5 is a block diagram of a computing device for quantum service version request routing, according to one example; and

FIG. 6 is a block diagram of a quantum computing device suitable for implementing examples, according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first executing quantum service” and “second executing quantum service,” and does not imply a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the elements unless otherwise explicitly specified. The word “or” as used herein and in the claims is inclusive unless contextually impossible. As an example, the recitation of A or B means A, or B, or both A and B.

Quantum computing involves the use of quantum bits, referred to herein as “qubits,” which have characteristics that differ from those of classical (i.e., non-quantum) bits used in classical computing. Qubits may be employed by quantum services that are executed by quantum computing devices.

Quantum services that are executing on quantum computing devices in a quantum computing system may exist in various versions across the quantum computing devices. Each version may have different configurations and capabilities, so when a request for a quantum service is received, the request needs to be routed to the correct version of the quantum service. Therefore, a mechanism to determine which version of the quantum service a request should be routed to among the various versions is desired.

A quantum strangler service can be implemented to route a request for a quantum service to the best version of the quantum service based on several factors. The quantum strangler service can receive a request for a quantum service from a client computing device, decompose the request, and apply an algorithmic weighting to determine the best version of the quantum service to route the request to. The quantum strangler service can examine the capabilities and current state of the various versions of the quantum service and of the quantum computing devices in the quantum computing system. The capabilities and current state of the various versions of the quantum service and of the quantum computing devices can also be used in the algorithmic weighting to determine the best version of the quantum service to route the request to in order to ensure that the load on a version of the quantum service or a quantum computing device would not be excessive if the request were routed to that version of the quantum service.

Routing a request to access a quantum service to the best version of the quantum service for the request can be a part of a strangler pattern to gradually migrate legacy quantum services, where a quantum service (e.g., the quantum strangler service) acts as a façade that intercepts requests from client computing devices and routes the requests to either the legacy quantum service or newer versions of the quantum service. In a quantum computing system, the different versions of the quantum service may be running on different quantum computing devices within the quantum computing system that each have their own configurations. Additionally, the different versions of the quantum service may have different configurations, such as different error correction software, heat sensitivities, noise sensitivities, performance optimizations, or qubit types. The quantum strangler service can be implemented to route a request for the quantum service to the best version of the quantum service among the versions that are running on the different quantum computing devices based on the configurations of the various versions of the quantum service and of the quantum computing devices.

The request may include a quantum instruction file (QIF) and the quantum strangler service can decompose the request by parsing the QIF to determine the needs for the quantum service to be accessed. By analyzing these request parameters and the capabilities and current state (i.e., the configurations) of the various versions of the quantum service and of the quantum computing devices, the quantum strangler service can determine which version of the quantum service is the best version to receive the request. For instance, a weighing algorithm can take the request parameters and the capabilities and current state of the various versions of the quantum service and of the quantum computing devices as input and weigh the inputs to determine which version of the quantum service is the best version to receive the request, such as by determining that routing the request to some versions of the quantum service would excessively increase the load on a quantum service or quantum computing device.

The capabilities and current state of the various versions of the quantum service can be determined based on a mapping table that includes the capabilities and the current state of each version of the quantum service, such as the error correction software, heat sensitivities, noise sensitivities, performance optimizations, or qubit types of the quantum service versions. The capabilities and current state of the quantum computing devices may also be determined based on a mapping table that includes the capabilities and the current state of each quantum computing device, such as the error count, type of error correction software, current heat, heat threshold, current noise, noise threshold, qubit types, number of available qubits, or T1 and T2 times, or the quantum strangler service may use a hardware API to identify the capabilities and the current state of each quantum computing device. The mapping tables can also be updated in real-time based on the current capabilities and current state of the different versions of the quantum service and the different quantum computing devices.

Once the best version of the quantum service for receiving the request is determined, the quantum strangler service can route the request to that version of the quantum service. In some cases, that version of the quantum service may be unavailable, and the quantum strangler service can wait for a period of time before trying to route the request again, then continue this pattern until the request is successfully routed to the quantum service.

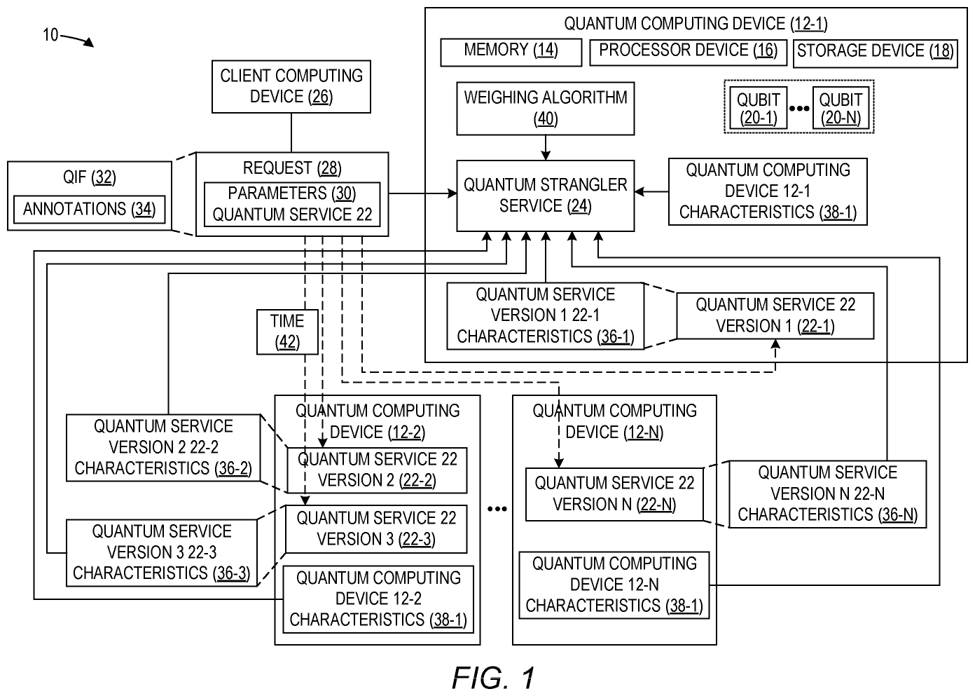

FIG. 1 is a block diagram of a quantum computing system 10 that includes a quantum computing device 12-1 that comprises a system memory 14, a processor device 16, and a storage device 18. The quantum computing system 10 may include additional quantum computing devices in addition to the quantum computing device 12-1, such as a plurality of quantum computing devices 12-1-12-N (collectively, quantum computing devices 12), each comprising a system memory, a processor device, and a storage device. It is to be understood that the quantum computing devices 12 in some examples may include constituent elements in addition to those illustrated in FIG. 1. In examples where the quantum computing device 12-1 comprises software instructions that program the processor device 16 to carry out functionality discussed herein, functionality implemented by the quantum computing device 12-1 may be attributed herein to the processor device 16. In the example of FIG. 1, the quantum computing device 12-1 implements a quantum strangler service 24 that performs quantum service version request routing.

In the example of FIG. 1, the quantum computing device 12-1 implements a set of one or more qubits 20-1-20-N (collectively, qubits 20) for use by quantum services executed by the quantum computing device 12-1. To maintain information for the qubits 20, the quantum computing device 12-1 includes a qubit registry (not illustrated), which comprises a plurality of qubit registry entries each corresponding to a qubit of the qubits 20. The qubit registry maintains and provides access to data relating to the qubits implemented by the quantum computing device 12-1, such as a count of the total number of qubits implemented by the quantum computing device 12-1 and a count of the number of available qubits that are currently available for allocation, as non-limiting examples. Each of the qubit registry entries of the qubit registry also stores qubit metadata for a corresponding qubit. The qubit metadata may include, as non-limiting examples, an identifier of the corresponding qubit, an availability indicator that indicates whether the corresponding qubit is available for use or is in use by a specific quantum service, an identifier of a quantum service that is associated with the corresponding qubit or to which the corresponding qubit is allocated, and/or an quantum phenomena indicator that indicates whether the corresponding qubit is in an entangled state and/or a superposition state.

The quantum computing device 12-1 of FIG. 1 executes one or more quantum services, such as the quantum service version 22-1. The quantum service version 22-1 is a process that employs qubits such as the qubits 20 to provide desired functionality. Execution of quantum services such as the quantum service version 22-1 is facilitated by a quantum service manager and a quantum service scheduler. The quantum service manager of the quantum computing device 12-1 handles operations for creating, monitoring, and terminating quantum services, while the quantum service scheduler of the quantum computing device 12-1 controls the scheduling of quantum services for execution by the processor device 16, and allocation of processing resources to executing quantum services. The functionality of the quantum service manager and the quantum service scheduler may be made accessible to other processes (e.g., via a defined application programming interface (API), as a non-limiting example).

The quantum strangler service 24 may receive a request 28 from a client computing device 26, such as a message, command line requests or API request. The request 28 can be a request to use or access a quantum service 22, and there may be a plurality of versions 22-1-22-N of the quantum service 22. For instance, each of the plurality of versions 22-1-22-N of the quantum service 22 may be the quantum service 22 with different configurations, such as the error correction software or heat sensitivities for the quantum service version. The plurality of versions 22-1-22-N of the quantum service 22 may execute on the plurality of quantum computing devices 12-1-12-N of the quantum computing system 10. For example, the quantum service version 22-1 may execute on the quantum computing device 12-1, quantum service version 22-2 and quantum service version 22-3 may execute on quantum computing device 12-2, and quantum service version 22-N may execute on quantum computing device 12-N. The plurality of versions 22-1-22-N of the quantum service 22 may execute on different quantum computing devices of the quantum computing devices 12, some of the plurality of versions 22-1-22-N of the quantum service 22 may execute on the same quantum computing device while others execute on other quantum computing devices, or the plurality of versions 22-1-22-N of the quantum service 22 may execute on the same quantum computing device.

The request 28 may include parameters 30 associated with the quantum service 22. The parameters 30 may be encapsulated in a quantum instruction file (QIF). The QIF 32 may be a service definition file, instruction file, or script written in a quantum programming language, as non-limiting examples, that describes the quantum service 22, how to interface with the quantum service 22, and the parameters 30 for the quantum service 22, such as the type of qubits or error correction to use. For instance, a QIF 32 can include one or more annotations 34 that are associated with the parameters 30 associated with the quantum service 22. In examples where the request 28 includes the QIF 32, the quantum strangler service 24 can parse the QIF 32 to obtain the annotations 34 that are associated with the parameters 30 associated with the quantum service 22. For example, the annotations 34 may include the specific speed, location, or accuracy, that is requested for a quantum service, where speed, location, and accuracy are the parameters 30 associated with the quantum service 22.

The quantum strangler service 24 may identify characteristics 36-1-36-N (collectively, characteristics 36) of the plurality of versions 22-1-22-N of the quantum service 22. The characteristics 36 may include information about the plurality of versions 22-1-22-N of the quantum service 22, such as an error count, a type of error correction software, heat sensitivities, noise sensitivities, performance optimizations, or qubit types of each version of the quantum service, as non-limiting examples. The characteristics 36 of the plurality of versions 22-1-22-N of the quantum service 22 may be organized in a data structure, such as a table, that the quantum strangler service 24 can access to identify the characteristics 36 of each version of the quantum service 22.

The quantum strangler service 24 may identify characteristics 38-1-38-N (collectively, characteristics 38) of the quantum computing devices 12. The characteristics 38 may include information about the quantum computing devices 12, such as an error count, a type of error correction software, current heat, heat threshold, current noise, noise threshold, qubit types, a number of available qubits, or T1 and T2 times of each of the quantum computing devices, as non-limiting examples. The characteristics 38 of the quantum computing devices 12 may be organized in a data structure, such as a table, that the quantum strangler service 24 can access to determine the characteristics 38 of each of the quantum computing devices 12. The quantum strangler service 24 may also update the data structure by continually monitoring the quantum computing devices 12 and determining when at least one of the characteristics 38 of at least one of the quantum computing devices 12 changes, such as an increase in the heat or noise of a quantum computing device, and update the data structure to include the change. In some examples, an API may be used by the quantum strangler service 24 to identify the characteristics 38 of the quantum computing devices 12 by sending a request to the API for the characteristics 38 and receiving a response from the API with the characteristics 38.

The request 28, the characteristics 36 of the plurality of versions 22-1-22-N of the quantum service 22, and the characteristics 38 of the quantum computing devices 12 can be used by the quantum strangler service 24 to determine which version of the plurality of versions 22-1-22-N of the quantum service 22 is the optimal version of the quantum service 22 to route the request 28 to. For instance, the optimal version may be the version of the quantum service 22 on the quantum computing device that has the lowest load (e.g., a low error count, a low heat, many available qubits), which can be determined by a weighing algorithm 40. The quantum strangler service 24 can apply the weighing algorithm with the request 28, the characteristics 36 of the plurality of versions 22-1-22-N of the quantum service 22, and the characteristics 38 of the quantum computing devices 12 as input to the weighing algorithm 40 and the weighing algorithm 40 can produce an output comprising the optimal version of the quantum service 22 that the quantum strangler service 24 should route the request 28 to. For example, the quantum strangler service 24 may use the weighing algorithm 40 to determine which versions of the quantum service 22 meet the parameters 30 of the request 28 (e.g., speed or qubit type) and weigh the characteristics 36 of the quantum service 22 and the characteristics 38 of the quantum computing devices 12 to determine which versions of the quantum service 22 and which of the quantum computing devices 12 can handle the load of the request 28. When more than one of the plurality of versions 22-1-22-N of the quantum service 22 meets the parameters 30 of the request 28 and can handle the load of the request 28, the weighing algorithm 40 may determine which one of the versions produces the least load on the quantum computing system 10 as being the best version to receive the request 28, as one example. The quantum strangler service 24 can then route the request 28 from the client computing device 26 to the version of the quantum service 22 that has been selected as the best version of the quantum service 22 to receive the request 28. When none of the plurality of versions 22-1-22-N of the quantum service 22 meet the parameters 30 of the request 28 or can handle the load of the request 28, the quantum strangler service 24 may reject the request 28 and send an error message.

In some implementations, the quantum strangler service 24 may determine that the version that has been selected as the optimal version of the quantum service 22 to receive the request 28 is unavailable. For instance, the version of the quantum service 22 may be down, paused, or have too much traffic, as non-limiting examples. The quantum strangler service 24 may, prior to routing the request 28, wait a predetermined period of time 42. The predetermined period of time 42 may be programmed, such as a time of several seconds, and the quantum strangler service 24 may again attempt to route the request 28 to the version that has been selected as the optimal version of the quantum service 22 once the predetermined period of time 42 has elapsed. If the version that has been selected as the optimal version of the quantum service 22 to receive the request 28 is still unavailable, the quantum strangler service 24 may again wait for the predetermined period of time 42 before attempting to route the request 28. In some examples, the quantum strangler service 24 may continue to wait and attempt to route the request 28 for an indefinite period, or the request 28 may be terminated after a predetermined number of attempts to route the request 28 to the version that has been selected as the optimal version of the quantum service 22 have occurred.

It is to be understood that, because the quantum strangler service 24 is a component of the quantum computing device 12-1, functionality implemented by the quantum strangler service 24 may be attributed to the quantum computing device 12-1 generally. Moreover, in examples where the quantum strangler service 24 comprises software instructions that program the processor device 16 to carry out functionality discussed herein, functionality implemented by the quantum strangler service 24 may be attributed herein to the processor device 16. It is to be further understood that while, for purposes of illustration only, the quantum strangler service 24 is depicted as a single component, the functionality implemented by the quantum strangler service 24 may be implemented in any number of components, and the examples discussed herein are not limited to any particular number of components. It is further noted that, although the quantum strangler service 24 is illustrated as being implemented on the quantum computing device 12-1, in other implementations, the quantum strangler service 24 may be implemented on a classical computing device. Thus, the quantum strangler service 24 may be implemented on a computing device that is either a classical computing device or a quantum computing device.

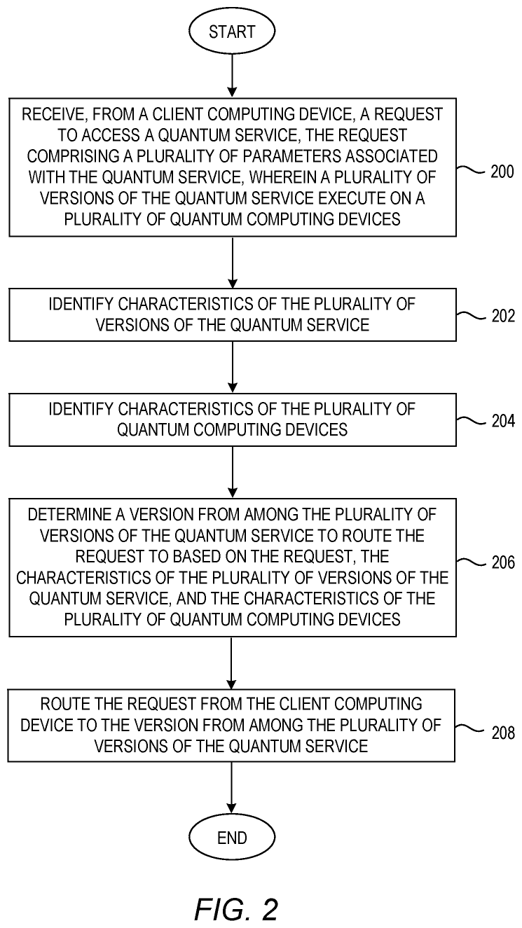

FIG. 2 is a flowchart illustrating operations performed by the quantum computing system of FIG. 1 for quantum service version request routing, according to one example. Elements of FIG. 1 are referenced in describing FIG. 2 for the sake of clarity. In the example of FIG. 2, operations begin with a processor device of a computing device, such as the processor device 16 of the quantum computing device 12-1 of FIG. 1, to receive, from a client computing device, a request to access a quantum service, the request comprising a plurality of parameters associated with the quantum service, wherein a plurality of versions of the quantum service execute on a plurality of quantum computing devices (block 200). The processor device 16 is then to identify characteristics of the plurality of versions of the quantum service (block 202). The processor device 16 is then to identify characteristics of the plurality of quantum computing devices (block 204). The processor device 16 is then to determine a version from among the plurality of versions of the quantum service to route the request to based on the request, the characteristics of the plurality of versions of the quantum service, and the characteristics of the plurality of quantum computing devices (block 206). The processor device 16 is then to route the request from the client computing device to the version from among the plurality of versions of the quantum service (block 208).

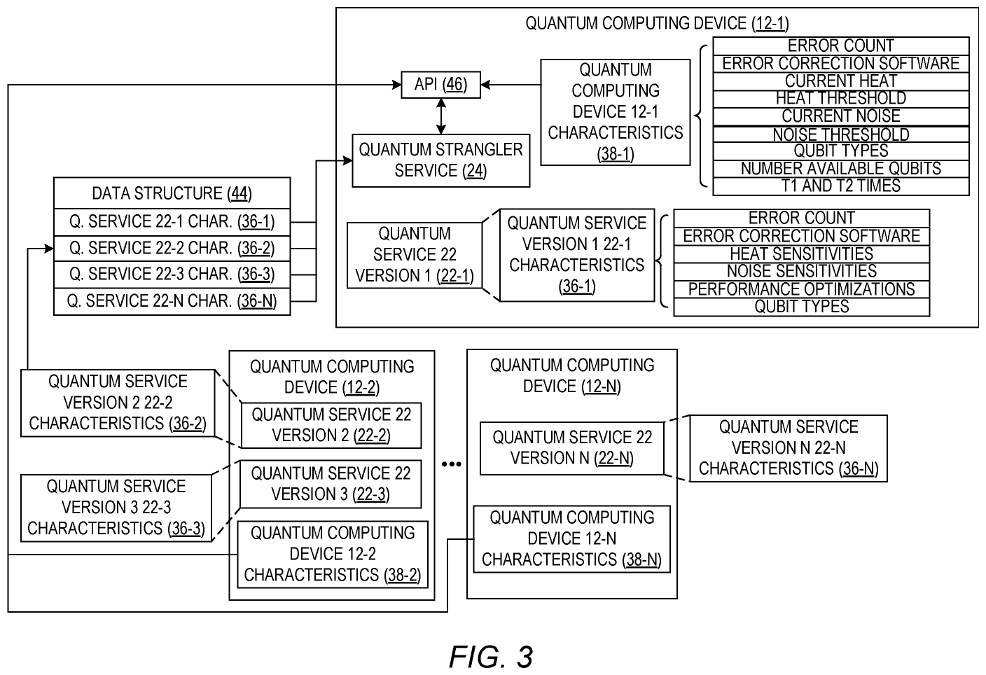

FIG. 3 is a block diagram of the quantum computing system of FIG. 1 for quantum service version request routing, according to one example. Elements of FIG. 1 are referenced in describing FIG. 3 for the sake of clarity. In the example of FIG. 3, the quantum strangler service 24 may identify the characteristics 36 of the plurality of versions 22-1-22-N of the quantum service 22 by accessing a data structure 44 (e.g., a table) that includes the characteristics 36 of each of the plurality of versions 22-1-22-N of the quantum service 22. The quantum strangler service 24 can access the data structure 44 to obtain the characteristics 36 of each of the plurality of versions 22-1-22-N of the quantum service 22, which may include one or more of an error count, a type of error correction software, heat sensitivities, noise sensitivities, performance optimizations, or qubit types of each of the plurality of versions 22-1-22-N of the quantum service 22.

The data structure 44 can provide a real-time view of the current capabilities of each of the plurality of versions 22-1-22-N of the quantum service 22 via the characteristics 36. For instance, the quantum strangler service 24 can identify when a change to at least one version of the plurality of versions 22-1-22-N of the quantum service 22 has occurred and update the data structure 44 to include the change. For example, the quantum service version 22-1 may have an error count of one error, the quantum strangler service 24 may be continually monitoring the plurality of versions 22-1-22-N of the quantum service 22 and determine that an error occurred with the quantum service version 22-1 and the error count of the quantum service version 22-1 is now two errors. The quantum strangler service 24 can update the data structure 44 by changing the quantum service version 22-1 characteristics 36-1 to identify the error count of the quantum service version 22-1 as two errors instead of one error. When the quantum strangler service 24 subsequently accesses the data structure 44 to identify the characteristics 36 of the plurality of versions 22-1-22-N of the quantum service 22, the quantum strangler service 24 will be able to obtain the updated error count within the quantum service version 22-1 characteristics 36-1 of the data structure 44.

The quantum strangler service 24 may identify the characteristics 38 of the quantum computing devices 12 by sending a request to an API 46, such as a quantum hardware API, for each of the quantum computing devices 12. The API 46 may return the characteristics 38 of each of the quantum computing devices 12, and the quantum strangler service 24 can receive the response with the characteristics 38 of each of the quantum computing devices 12. The characteristics 38 received by the quantum strangler service 24 from the API 46 may include one or more of an error count, a type of error correction software, current heat, heat threshold, current noise, noise threshold, qubit types, a number of available qubits, or T1 and T2 times of each of the quantum computing devices 12.

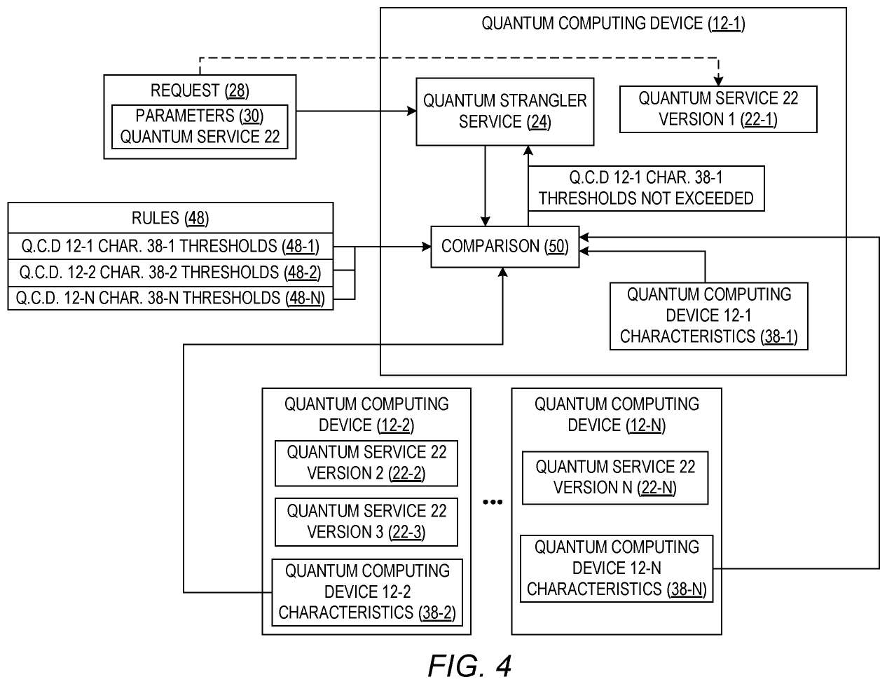

FIG. 4 is a block diagram of the quantum computing system of FIG. 1 for quantum service version request routing, according to one example. Elements of FIG. 1 are referenced in describing FIG. 4 for the sake of clarity. In the example of FIG. 4, the quantum strangler service 24 may determine, based on the request 28, the characteristics 36 of the plurality of versions 22-1-22-N of the quantum service 22, and the characteristics 38 of the quantum computing devices 12, which version of the plurality of versions 22-1-22-N of the quantum service 22 is the optimal version of the quantum service 22 to route the request 28 to by using a set of rules 48. The rules 48 may be stored in a data structure (e.g., a table) or database that can be accessed by the quantum strangler service 24. The rules 48 can include thresholds for the characteristics 38 of the quantum computing devices 12. For instance, rule 48-1 can include the thresholds for each of the characteristics 38-1 of the quantum computing device 12-1. Alternatively, each of the rules 48 can be a threshold for a particular characteristic for a particular quantum computing device, such as a rule with a threshold for the heat of the quantum computing device 12-1, a rule with a threshold for the noise of the quantum computing device 12-1, a rule with a threshold for the heat of the quantum computing device 12-2, and so on for each of the characteristics 38 for each of the quantum computing devices 12.

The quantum strangler service 24 can access the rules 48 and perform a comparison 50 of the characteristics 38 of the quantum computing devices 12 and the rules 48. Based on the comparison 50, the quantum strangler service 24 can determine that at least one quantum computing device of the quantum computing devices 12 does not exceed the thresholds for that quantum computing device as described in the rules 48. The version of the quantum service that is executing on that quantum computing device can be the version of the quantum service that the quantum strangler service 24 routes the request 28 to (i.e., the optimal version of the quantum service 22) since the thresholds for that quantum computing device are not exceeded.

Additionally, the quantum strangler service 24 may compare the characteristics 36 of the plurality of versions 22-1-22-N of the quantum service 22 to thresholds for the characteristics 36 of the plurality of versions 22-1-22-N, which may be an additional set of rules within the rules 48 or another set of rules associated with the quantum service 22 and stored in a data structure or database accessible by the quantum strangler service 24. Based on the comparison, the quantum strangler service 24 can determine that at least one version of the plurality of versions 22-1-22-N of the quantum service 22 does not exceed the thresholds for that version of the quantum service 22 as described in the rules. The at least one version of the plurality of versions 22-1-22-N of the quantum service 22 can be the version of the quantum service that the quantum strangler service 24 routes the request 28 to (i.e., the optimal version of the quantum service 22) since that version of the quantum service 22 does not exceed the thresholds.

In another example, the quantum strangler service 24 may both perform the comparison 50 of the characteristics 38 of the quantum computing devices 12 to the rules 48 that include thresholds for the characteristics 38 of the quantum computing devices 12 and perform the comparison of the characteristics 36 of the plurality of versions 22-1-22-N of the quantum service 22 to the thresholds for the characteristics 36 of the plurality of versions 22-1-22-N. Based on these two comparisons, the quantum strangler service 24 can determine the quantum computing device with the version of the quantum service 22 to route the request 28 to (i.e., the optimal version of the quantum service 22) as the version that does not exceed the thresholds for the quantum computing device and the version of the quantum service 22 that is running on that quantum computing device.

The quantum strangler service 24 may determine, based on the request 28, the characteristics 36 of the plurality of versions 22-1-22-N of the quantum service 22, and the characteristics 38 of the quantum computing devices 12, which version of the plurality of versions 22-1-22-N of the quantum service 22 is the optimal version of the quantum service 22 to route the request 28 to by determining whether a number of errors of at least one quantum computing device of the quantum computing devices 12 exceeds a threshold number of errors. For example, the errors may be an excessive number of errors, excessive heat, or excessive noise on the quantum computing device, as non-limiting examples. The thresholds may be thresholds for a specific type of error for all of the quantum computing devices 12 (e.g., a heat limit that applies to all of the quantum computing devices 12) or thresholds for a particular quantum computing device (e.g., a noise limit for quantum computing device 12-1 and another noise limit for quantum computing device 12-2). The thresholds for errors may be stored in a data structure that can be accessed by the quantum strangler service 24. The quantum strangler service 24 can identify the current amount of errors on the quantum computing devices 12 to compare with the thresholds and determine that the number of errors of at least one of the quantum computing devices 12 exceeds the threshold number of errors. When the quantum strangler service 24 determines that the number of errors of at least one of the quantum computing devices 12 exceeds the threshold number of errors, the quantum strangler service 24 can exclude the version of the quantum service 22 that is executing on that quantum computing device from receiving the request 28. For example, the quantum strangler service 24 may determine that the quantum computing device 12-1 has a number of errors that exceed a threshold number of errors and exclude the quantum service version 22-1 from receiving the request 28.

The quantum strangler service 24 may factor in the load on the quantum computing system 10 when determining which version of the plurality of versions 22-1-22-N of the quantum service 22 is the optimal version of the quantum service 22 to route the request 28 to. For instance, the quantum strangler service 24 may determine the amount of versions of the quantum service 22 that are executing on each of the quantum computing devices 12 and use the characteristics 36 of the plurality of versions 22-1-22-N of the quantum service 22 and the characteristics 38 of the quantum computing devices 12 to determine that routing the request 28 to a particular version of the quantum service 22 on a particular quantum computing device would overload that quantum computing device (e.g., produce excessive heat, noise, or errors).

For example, the quantum strangler service 24 may identify that the quantum service version 22-1 is executing on the quantum computing device 12-1, the quantum service version 22-2 and the quantum service version 22-3 are executing on the quantum computing device 12-2, and the quantum service version 22-N is executing on the quantum computing device 12-N. The characteristics 38 of the quantum computing devices 12 may indicate that the current heat of the quantum computing device 12-2 is approaching the heat threshold for the quantum computing device 12-2, and the quantum strangler service 24 may determine that routing the request 28 to a quantum service version that is executing on the quantum computing device 12-2 (e.g., the quantum service version 22-2 or the quantum service version 22-3) will cause the current heat of the quantum computing device 12-2 to exceed the heat threshold for the quantum computing device 12-2. As a result, the quantum strangler service 24 can determine that the request 28 should not be routed to the quantum service version 22-2 or the quantum service version 22-3 and should be routed to another quantum service version instead (i.e., the quantum service version 22-2 and the quantum service version 22-3 are not the optimal version of the quantum service 22 to route the request 28 to).

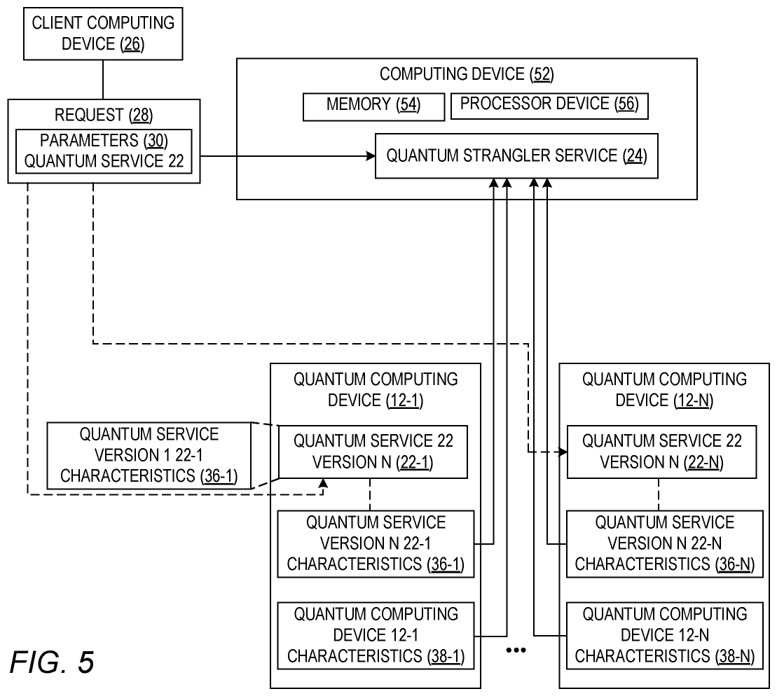

FIG. 5 is a block diagram of a computing device for quantum service version request routing, according to one example. Elements of FIG. 1 are referenced in describing FIG. 5 for the sake of clarity. In the example of FIG. 5, a computing device 52, such as a classical computing device, comprises a system memory 54 and a processor device 56 coupled to the system memory 54. The processor device 56 is to receive, from the client computing device 26, the request 28 to access the quantum service 22, the request 28 comprising the plurality of parameters 30 associated with the quantum service 22, wherein the plurality of versions 22-1-22-N of the quantum service 22 execute on the plurality of quantum computing devices 12-1-12-N. The processor device 56 is further to identify the characteristics 36-1-36-N of the plurality of versions 22-1-22-N of the quantum service 22. The processor device 56 is further to identify the characteristics 38-1-38-N of the plurality of quantum computing devices 12-1-12-N. The processor device 56 is further to determine a version from among the plurality of versions 22-1-22-N of the quantum service 22 to route the request 28 to based on the request 28, the characteristics 36-1-36-N of the plurality of versions 22-1-22-N of the quantum service 22, and the characteristics 38-1-38-N of the plurality of quantum computing devices 12-1-12-N. The processor device 56 is further to route the request 28 from the client computing device 26 to the version from among the plurality of versions 22-1-22-N of the quantum service 22.

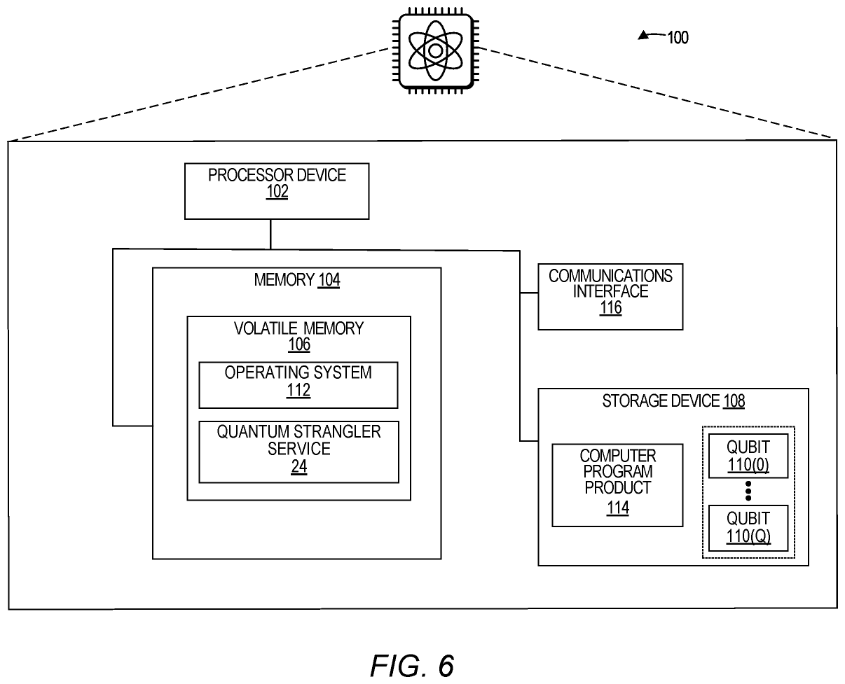

FIG. 6 is a block diagram of a quantum computing device 100, such as the quantum computing device 12-1 of FIG. 1, suitable for implementing examples, according to one example. As noted above, although solely for purposes of illustration the quantum strangler service 24 is illustrated in the Figures as executing on a quantum computing device, in other implementations, the quantum strangler service 24 may be implemented on a classical computing device. The quantum computing device 100 may comprise any suitable quantum computing device or devices. The quantum computing device 100 can operate using classical computing principles or quantum computing principles. Thus, in some implementations, portions of the quantum computing device 100 (e.g., the quantum strangler service 24) may be executed using classical computing components and/or algorithms. When using quantum computing principles, the quantum computing device 100 performs computations that utilize quantum-mechanical phenomena, such as superposition and entanglement. The quantum computing device 100 may operate under certain environmental conditions, such as at or near zero degrees (0°) Kelvin. When using classical computing principles, the quantum computing device 100 utilizes binary digits that have a value of either zero (0) or one (1).

The quantum computing device 100 includes a processor device 102 and a system memory 104. The processor device 102 can be any commercially available or proprietary processor suitable for operating in a quantum environment. The system memory 104 may include volatile memory 106 (e.g., random-access memory (RAM)).

The quantum computing device 100 may further include or be coupled to a non-transitory computer-readable medium such as a storage device 108. The storage device 108 may comprise, for example, an internal or external hard disk drive (HDD) (e.g., enhanced integrated drive electronics (EIDE) or serial advanced technology attachment (SATA)) for storage, memory, or the like. The storage device 108 and other drives associated with computer-readable media and computer-usable media may provide non-volatile storage of data, data structures, computer-executable instructions, and the like. The storage device may also provide functionality for storing one or more qubits 110(0)-110(Q).

A number of modules can be stored in the storage device 108 and in the volatile memory 106, including an operating system 112 and one or more modules, such as the quantum strangler service 24. All or a portion of the examples may be implemented as a computer program product 114 stored on a transitory or non-transitory computer-usable or computer-readable medium, such as the storage device 108, which includes complex programming instructions, such as complex computer-readable program code, to cause the processor device 102 to carry out the steps described herein. Thus, the computer-readable program code can comprise computer-executable instructions for implementing the functionality of the examples described herein when executed on the processor device 102.

An operator may also be able to enter one or more configuration commands through a keyboard (not illustrated), a pointing device such as a mouse (not illustrated), or a touch-sensitive surface such as a display device (not illustrated). The quantum computing device 100 may also include a communications interface 116 suitable for communicating with other quantum computing systems, including, in some implementations, classical computing devices.

Individuals will recognize improvements and modifications to the preferred examples of the disclosure. All such improvements and modifications are considered within the scope of the concepts disclosed herein and the claims that follow.

What is claimed is:

1. A method, comprising:
receiving, by a computing device from a client computing device, a request to access a quantum service, the request comprising a plurality of parameters associated with the quantum service, wherein a plurality of versions of the quantum service execute on a plurality of quantum computing devices;
identifying, by the computing device, characteristics of the plurality of versions of the quantum service;
identifying, by the computing device, characteristics of the plurality of quantum computing devices;
determining, by the computing device, a version from among the plurality of versions of the quantum service to route the request to based on the request, the characteristics of the plurality of versions of the quantum service, and the characteristics of the plurality of quantum computing devices; and
routing, by the computing device, the request from the client computing device to the version from among the plurality of versions of the quantum service.

2. The method of claim 1, wherein the request comprises a quantum instruction file (QIF) comprising one or more annotations associated with the plurality of parameters associated with the quantum service.

3. The method of claim 2, further comprising:
subsequent to receiving, from the client computing device, the request, parsing the QIF to obtain the one or more annotations associated with the plurality of parameters associated with the quantum service.

4. The method of claim 1, wherein identifying the characteristics of the plurality of versions of the quantum service comprises accessing a data structure comprising characteristics of each version of the plurality of versions of the quantum service to obtain the characteristics of the plurality of versions of the quantum service.

5. The method of claim 4, further comprising:
identifying a change to at least one version of the plurality of versions of the quantum service; and
updating the data structure to include the change to the at least one version of the plurality of versions of the quantum service.

6. The method of claim 1, wherein the characteristics of the plurality of versions of the quantum service comprises one or more of an error count, a type of error correction software, heat sensitivities, noise sensitivities, performance optimizations, or qubit types of the plurality of versions of the quantum service.

7. The method of claim 1, wherein identifying the characteristics of the plurality of quantum computing devices comprises:
sending a request to an API for each quantum computing device of the plurality of quantum computing devices; and
receiving, from the API, a response comprising the characteristics of each quantum computing device of the plurality of quantum computing devices.

8. The method of claim 1, wherein the characteristics of the plurality of quantum computing devices comprises one or more of an error count, a type of error correction software, current heat, heat threshold, current noise, noise threshold, qubit types, a number of available qubits, or T1 and T2 times of the plurality of quantum computing devices.

9. The method of claim 1, wherein determining the version from among the plurality of versions of the quantum service to route the request to based on the request, the characteristics of the plurality of versions of the quantum service, and the characteristics of the plurality of quantum computing devices comprises:
applying a weighing algorithm to the request, the characteristics of the plurality of versions of the quantum service, and the characteristics of the plurality of quantum computing devices, wherein the weighing algorithm determines an optimal version of the quantum service to route the request to.

10. The method of claim 1, wherein determining the version from among the plurality of versions of the quantum service to route the request to based on the request, the characteristics of the plurality of versions of the quantum service, and the characteristics of the plurality of quantum computing devices comprises:
accessing a set of rules including thresholds for the characteristics of the plurality of quantum computing devices;
performing a comparison of the characteristics of the plurality of quantum computing devices and the set of rules; and
determining, based on the comparison, that at least one quantum computing device of the plurality of quantum computing devices does not exceed the thresholds for the characteristics of the plurality of quantum computing devices, wherein the version from among the plurality of versions of the quantum service to route the request to is executing on the at least one quantum computing device of the plurality of quantum computing devices.

11. The method of claim 1, wherein determining the version from among the plurality of versions of the quantum service to route the request to based on the request, the characteristics of the plurality of versions of the quantum service, and the characteristics of the plurality of quantum computing devices comprises:
determining, based on the characteristics of the plurality of quantum computing devices, that at least one quantum computing device of the plurality of quantum computing devices has a number of errors that exceeds a threshold; and
in response to determining that the at least one quantum computing device of the plurality of quantum computing devices has a number of errors that exceeds the threshold, excluding a version of the quantum service executing on the at least one quantum computing device from receiving the request.

12. The method of claim 1, further comprising:
determining that the version from among the plurality of versions of the quantum service to route the request to is unavailable;
waiting a predetermined period of time; and
subsequent to waiting the predetermined period of time, routing the request from the client computing device to the version from among the plurality of versions of the quantum service.

13. The method of claim 1, wherein each version of the plurality of versions of the quantum service executes on a different quantum computing device from among the plurality of quantum computing devices.

14. A computing device, comprising:
a memory; and
a processor device coupled to the memory, the processor device to:
receive, from a client computing device, a request to access a quantum service, the request comprising a plurality of parameters associated with the quantum service, wherein a plurality of versions of the quantum service execute on a plurality of quantum computing devices;
identify characteristics of the plurality of versions of the quantum service;
identify characteristics of the plurality of quantum computing devices;
determine a version from among the plurality of versions of the quantum service to route the request to based on the request, the characteristics of the plurality of versions of the quantum service, and the characteristics of the plurality of quantum computing devices; and
route the request from the client computing device to the version from among the plurality of versions of the quantum service.

15. The computing device of claim 14, wherein the processor device is further to:
subsequent to receiving, from the client computing device, the request, parse a quantum instruction file (QIF) comprising one or more annotations associated with the plurality of parameters associated with the quantum service to obtain the one or more annotations associated with the plurality of parameters associated with the quantum service.

16. The computing device of claim 14, wherein, to identify characteristics of the plurality of versions of the quantum service, the processor device is further to:
access a data structure comprising characteristics of each version of the plurality of versions of the quantum service to obtain the characteristics of the plurality of versions of the quantum service.

17. The computing device of claim 14, wherein, to identify characteristics of the plurality of quantum computing devices, the processor device is further to:
send a request to an API for each quantum computing device of the plurality of quantum computing devices; and
receive, from the API, a response comprising the characteristics of each quantum computing device of the plurality of quantum computing devices.

18. The computing device of claim 14, wherein, to determine the version from among the plurality of versions of the quantum service to route the request to based on the request, the characteristics of the plurality of versions of the quantum service, and the characteristics of the plurality of quantum computing devices, the processor device is further to:
apply a weighing algorithm to the request, the characteristics of the plurality of versions of the quantum service, and the characteristics of the plurality of quantum computing devices, wherein the weighing algorithm determines an optimal version of the quantum service to route the request to.

19. The computing device of claim 14, wherein, to determine the version from among the plurality of versions of the quantum service to route the request to based on the request, the characteristics of the plurality of versions of the quantum service, and the characteristics of the plurality of quantum computing devices, the processor device is further to:
access a set of rules including thresholds for the characteristics of the plurality of quantum computing devices;
perform a comparison of the characteristics of the plurality of quantum computing devices and the set of rules; and
determine, based on the comparison, that at least one quantum computing device of the plurality of quantum computing devices does not exceed the thresholds for the characteristics of the plurality of quantum computing devices, wherein the version from among the plurality of versions of the quantum service to route the request to is executing on the at least one quantum computing device of the plurality of quantum computing devices.

20. A non-transitory computer-readable storage medium that includes computer-executable instructions that, when executed, cause one or more processor devices to:
receive, from a client computing device, a request to access a quantum service, the request comprising a plurality of parameters associated with the quantum service, wherein a plurality of versions of the quantum service execute on a plurality of quantum computing devices;
identify characteristics of the plurality of versions of the quantum service;
identify characteristics of the plurality of quantum computing devices;
determine a version from among the plurality of versions of the quantum service to route the request to based on the request, the characteristics of the plurality of versions of the quantum service, and the characteristics of the plurality of quantum computing devices; and
route the request from the client computing device to the version from among the plurality of versions of the quantum service.
